(19) United States
(12) Patent Application Publication
(10) Pub. No.: US 2006/0145034 A1
(43) Pub. Date: Jul. 6, 2006

(54) SCISSOR-TYPE SUPPORTER OF KEYBOARD

(76) Inventor: Ming-Fu Yen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,870

(22) Filed: Jan. 25, 2005

(30) Foreign Application Priority Data
Dec. 31, 2004 (TW) 093221470

(51) Int. Cl. B43L 15/00

(52) U.S. Cl. 248/122.1

(57) ABSTRACT

A scissor-type supporter is disclosed. The scissor-type supporter includes a first supporter and a second supporter. The first supporter includes a first pivot and a second pivot, wherein the first pivot and the second pivot are on the opposite sides of the first supporter. The second supporter includes a first pivotal hole for receiving the first pivot, a second pivotal hole for receiving the second pivot, and a first tapered guider connected to the first pivotal hole for guiding the first pivot into the first pivotal hole.

### BACKGROUND OF INVENTION

1. Field of the Invention

The invention relates to a scissor-type supporter, and more particularly, to a scissor-type supporter of a keyboard.

2. Description of the Prior Art

Please refer to FIG. 1, a diagram of a keyboard bottom 10 according to the prior art. As shown in FIG. 1, the keyboard bottom 10 comprises a bottom headgear 11, an elastic mechanism 12, a first supporter 13, a second supporter 14, and a substrate 15. The first supporter 13 has pivots in the middle of the first supporter 13, and the second supporter 14 has pivotal holes in the middle of the second supporter 14. The pivots can be connected into the pivotal holes so that the first supporter 13 and the second supporter 14 can be connected as a cross-shaped mechanism. The elastic mechanism 12 is installed between the bottom headgear 11 and the substrate 15. That is, the elastic mechanism 12 lies in the moving route of the bottom headgear 11. Therefore, when a user pushes the bottom headgear 11, the elastic mechanism 12 provides a reverse force to the bottom headgear 11 so that the bottom headgear 11 can move to the original position of the bottom headgear 11.

Please refer to FIG. 2, which is a diagram of the first supporter 13 and the second supporter 14 shown in FIG. 1. As shown in FIG. 2, the first supporter 13 comprises two pivots 16 and 17, and the second supporter 14 comprises two pivotal holes 18 and 19. As mentioned above, the first supporter 13 is connected to the second supporter 14 through the pivots 16 and 17, and the pivotal holes 18 and 19. In other words, the pivot 16 is connected into the pivotal hole 18 and the pivot 17 is connected into the pivotal hole 19.

In the above-mentioned keyboard 10 structure, it is complex to compose the first supporter 13 and the second supporter 14. Generally speaking, an operator must first connect the pivot 16 of the first supporter 13 into the pivotal hole 18 of the second supporter 18. Finally, the operator compresses the second supporter 14 to change its shape so that the operator can connect another pivot 17 of the first supporter 13 to another pivotal hole 19 of the second supporter 19. But in fact, the above-mentioned composing method may cause damage to the supporters 13 and 14. For example, because the pivotal holes 18 and 19 are located in the middle of the second supporter 14, the middle of the second supporter 14 is its weakest at the middle location and is unable to withstand much compressing force. Therefore, when the operator compresses the second supporter 14, the middle of the second supporter 14 (i.e., the position of the pivotal holes 18 and 19) is easily broken.

Additionally, as shown in FIG. 1 and FIG. 2, the first supporter 13 and the second supporter 14 can be composed with an up-down composition. For example, the pivotal holes 18 and 19 are ball-shaped concave holes for receiving the pivots 16 and 17. Furthermore, the mouth of the concave hole is smaller than the diameter of the pivots 16 and 17. Therefore, when the operator combines the first supporter 13 and the second supporter 14, the operator has only to push the pivots 16 and 17 into the above-mentioned concave holes of the pivotal holes 18 and 19. Unfortunately the above-mentioned structure has another problem, as shown in FIG. 1, caused when the bottom 10 is pushed, the pivots 16 and 17 may have a reverse force (in FIG. 1, the direction of the force is up), the pivots 16 and 17 possibly leave the pivotal holes 18 and 19 such that the bottom 10 brakes.

Furthermore, regardless of the aforementioned bottom structure, the operator is required to compose the supporters. Therefore, the bottom is difficult to produce quickly by machines.

### SUMMARY OF INVENTION

It is therefore one of primary objectives of the claimed invention to provide a scissor-type supporter to solve the above-mentioned problem.

According to an exemplary embodiment of the claimed invention, a scissor-type supporter is disclosed. The scissor-type supporter comprises a first pivot and a second pivot, wherein the first and the second pivots are on opposite sides of the first supporter. The second supporter comprises a first pivotal hole for receiving the first pivot, a second pivotal hole for receiving the second pivot, and a first tapered guider connected to the first pivot for guiding the first pivot into the first pivotal hole.

The present invention scissor-type supporter can be composed quickly and does not require compression during composition therefore the scissor-type supporter resists being broken. Furthermore, the present invention avoids situations where the pivots may leave the pivotal holes due to the reverse force.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a keyboard bottom according to the prior art.

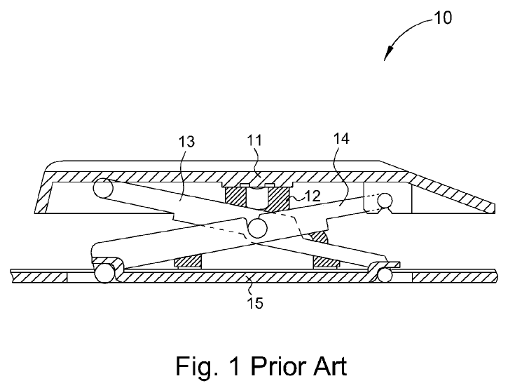

FIG. 2 is a diagram of a first supporter and a second supporter shown in FIG. 1.

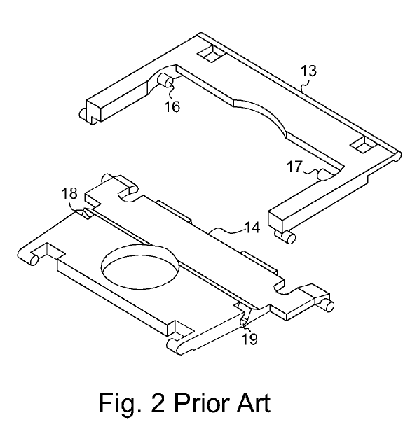

FIG. 3 is a diagram of a separated scissor-type supporter 100 according to the present invention.

FIG. 4 is a flow chart for composing the scissor-type 100 according to the present invention.

FIG. 5 is a diagram of the scissor-type supporter in step 400 shown in FIG. 4.

FIG. 6 is a diagram of the scissor-type supporter in step 402 shown in FIG. 4.

FIG. 7 is a diagram of the scissor-type supporter in step 404 shown in FIG. 4.

FIG. 8 is a combined scissor-type supporter according to the present invention.

### DETAILED DESCRIPTION

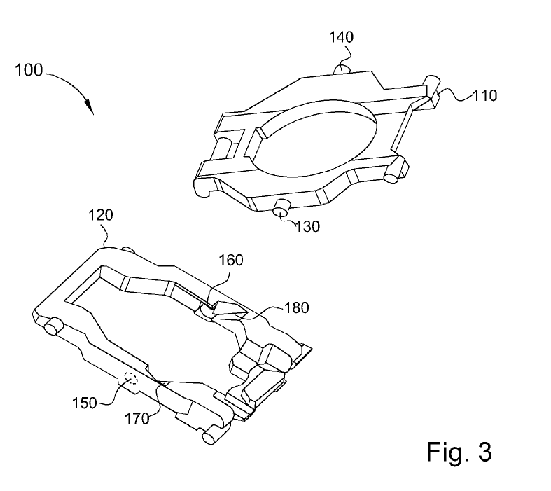

Please refer to FIG. 3, which is a diagram of a separated scissor-type supporter 100 according to the present invention. As shown in FIG. 3, the scissor-type supporter 100 comprises a first supporter 110 and a second supporter 120. Similarly, the first supporter 110 comprises two pivots 130 and 140 in the middle of the first supporter 110. The second supporter 120 comprises two pivotal holes 150 160 in the middle of the second supporter 120. The pivotal hole 150 receives the pivot 130 and the pivotal hole 160 receives the pivot 140. Therefore, the first supporter 110 can be connected to the second supporter 120 through the combination of the pivots 130 and 140 and the pivotal holes 150 and 160. Additionally, the second supporter 120 further comprises two tapered guiders 170 and 180 connected to the pivotal holes 150 and 160 for guiding the pivots 130 and 140 into the pivotal holes 150 and 160. The guiding method of the tapered guiders 170 and 180 is illustrated as follows.

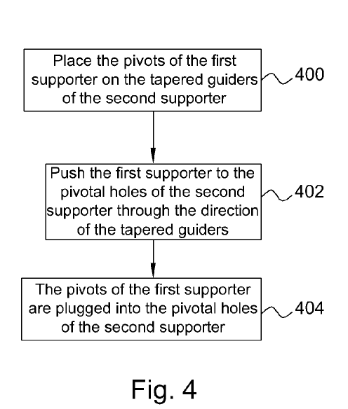

Please refer to FIG. 4, which is a flow chart of composing the scissor-type supporter 100 according to the present invention.

Step 400: Place the pivots 130 and 140 of the first supporter 110 on the tapered guiders 170 and 180 of the second supporter 120;

Step 402: Push the first supporter 110 to the pivotal holes 150 and 160 of the second supporter 120 through the direction of the tapered guiders 170 and 180;

Step 404: The pivots 130 and 140 of the first supporter 110 are plugged into the pivotal holes 150 and 160 of the second supporter.

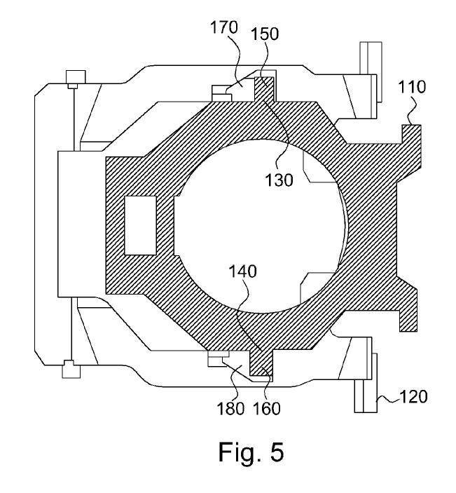

Please refer to FIG. 5, which is a diagram of the scissor-type supporter 100 corresponding to step 400 shown in FIG. 4. As shown in FIG. 5 (and also in FIG. 3), the tapered guiders 170 and 180 are slopes with different widths. The width connecting to the pivots 150 and 160 is narrow. Therefore, the pivots 130 and 140 of the first supporter 110 are placed on the wider of the two tapered guiders 170 and 180 (step 400).

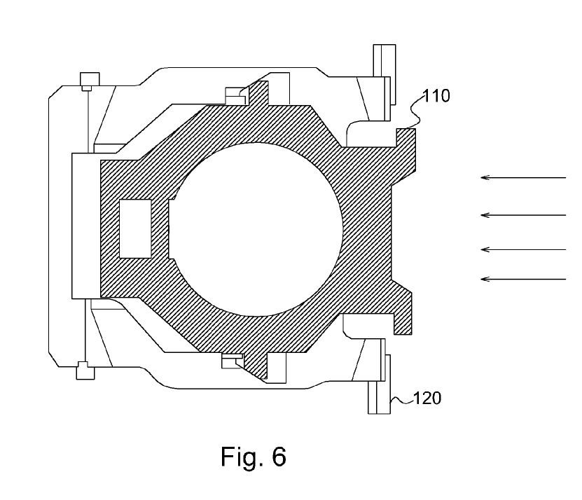

Please refer to FIG. 6, which is a diagram of the scissor-type supporter 100 corresponding to step 402 shown in FIG. 4. As shown in FIG. 6, the first supporter 110 is pushed into the pivot holes 150 and 160 through the direction of the tapered guiders 170 and 180 (step 402). Because the first supporter 110 is produced with a flexible material and the width of the tapered guiders 170 and 180 narrows, the first supporter 110 is not only moved toward the pivotal holes 150 and 160 but also pushed to change its shape.

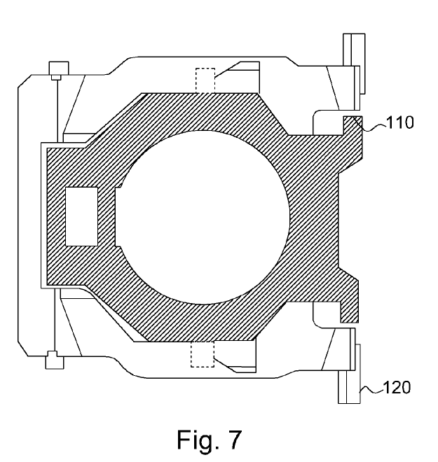

Please refer to FIG. 7, which is a diagram of the scissor-type supporter 100 corresponding to step 404 shown in FIG. 4. As shown in FIG. 7, step 402 causes the first supporter 110 to change its shape when pushed into the tapered and narrowing guiders 170 and 180 when the first supporter 110 is moved to the pivotal holes 150 and 160 through the direction of the tapered guiders 170 and 180, the pivots 130 and 140 of the first supporter 110 are plugged into the pivotal holes 150 and 160 because of its flexibility (step 404). Therefore, the pivots 130 and 140 can be plugged into the pivotal holes 150 and 160 correctly. In other words, the first supporter 110 and the second supporter 120 are composed completely.

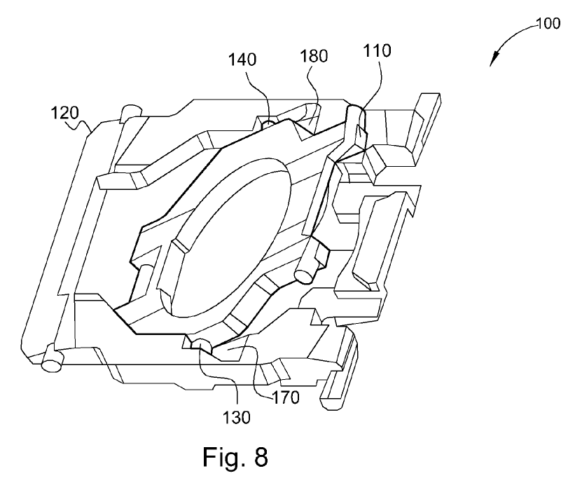

Please refer to FIG. 8, which is a combined scissor-type supporter 100 according to the present invention. As shown in FIG. 8, the first supporter 110 and the second supporter 120 are combined completely. Furthermore, the first supporter 110 can be rotated. The further operation and function of the scissor-type supporter 100 is well known and thus omitted here.

The pivots 130 and 140 and the pivotal holes 150 and 160 of the present invention are not combined through the aforementioned up-down combining method and the pivotal holes 150 and 160 have no mouth, therefore, when the bottom is pushed, the reverse force no longer exist so that the above-mentioned problem is solved. Furthermore, because the tapered guiders 170 and 180 provide combining tracks for combining the pivots 130 and 140 and the pivotal holes 150 and 160, the efficiency of composing the scissor-type supporter 100 is increased.

In the above-mentioned embodiment, the second supporter 120 comprises two tapered guiders 170 and 180. However, the second supporter 120 need only comprise a single tapered guider. For example, one tapered guider is connected to the pivotal hole 160. When combining the first supporter 110 and the second supporter 120, the pivot 130 can first be plugged into the pivotal hole 150; another pivot 140 can be pushed to the pivotal hole 160 through the tapered guider. As mentioned above, the pivot 140 can be plugged into the pivotal hole 160 because of its flexibility. Therefore, the two pivots 130 and 140 can successfully be plugged into the pivotal holes 150 and 160. Therefore, the number of the tapered guiders is an illustration but not a limitation. The two tapered guiders are only utilized as a preferred embodiment of the present invention.

In contrast to the prior art, the present invention scissor-type supporter can be composed quickly, does not break due to improper compression, and furthermore, the present invention prevents the pivots from leaving the pivotal holes due to the reverse force.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scissor-type supporter comprising:
a first supporter comprising:
a first pivot; and
a second pivot, the first pivot and the second pivot are on opposite sides of the first supporter; and
a second supporter comprising:
a first pivotal hole for receiving the first pivot;
a second pivotal hole for receiving the second pivot; and
a first tapered guider connected to the first pivotal hole for guiding the first pivot into the first pivotal hole.

2. The scissor-type supporter of claim 1, wherein the first tapered guider comprises a first side and a second side, the first side is adjacent to the first pivotal hole, and a width of the second side is bigger than that of the first side.

3. The scissor-type supporter of claim 1 being utilized in a keyboard of a computer.

4. The scissor-type supporter of claim 3, wherein the computer is a laptop.

5. The scissor-type supporter of claim 1, wherein the second supporter further comprises a second tapered guider connected to the second pivotal hole for guiding the second pivot to the second pivotal hole.

6. The scissor-type supporter of claim 5, wherein the first tapered guider comprises a first side and a second side, the first side is adjacent to the first pivotal hole, a width of the second side is bigger than that of the first side, the second tapered guider comprises a third side and a fourth side, the third side is adjacent to the second pivotal hole, and a width of the fourth side is bigger than that of the third side.
